(19) United States
(12) Patent Application Publication
(10) Pub. No.: US 2021/0005345 A1
(43) Pub. Date: Jan. 7, 2021

(54) USE OF A MIXTURE AS DIELECTRIC FLUID

(71) Applicant: Arkema France, Colombes (FR)

(72) Inventors: Jérémie Walker, Pierre-Benite Cedex (FR); Bernard Monguillon, Colombes (FR)

(73) Assignee: Arkema France, Colombes (FR)

(21) Appl. No.: 16/976,990

(22) PCT Filed: Mar. 6, 2019
(86) PCT No.: PCT/FR2019/050497

§ 371 Date: Aug. 31, 2020

(30) Foreign Application Priority Data
Mar. 8, 2018 (FR) 1852028

(51) Int. Cl. H01B 3/22; C09K 5/10

(52) U.S. Cl. CPC H01B 3/22; H01F 27/12; C09K 5/10

(57) ABSTRACT

The use of a mixture as dielectric fluid comprising a composition A comprising dibenzyltoluene and benzyltoluene for improving the service life of a transformer is described, in addition to a mixture comprising said composition A with at least one ester and optionally at least one additive, and a transformer comprising said composition A or a mixture comprising said composition A with at least one ester and optionally at least one additive.

The present invention relates to the use of a mixture comprising benzyltoluene and dibenzyltoluene as dielectric fluid, for improving the service life of a transformer. The invention also relates to specific mixtures comprising benzyltoluene and dibenzyltoluene.

Dielectric fluids are insulating materials conventionally used in electrical equipment such as high-voltage cables and transformers, in which they are impregnated on a solid material that acts as an insulator, such as a polypropylene film or paper, optionally a combination of the two, referred to as a “mixed film-paper” material.

The dielectric fluids market is in full expansion following the energy demand and demographic growth.

The dielectric fluids most commonly used in transformers are mineral oils, firstly on account of their physicochemical properties and secondly on account of their low cost and their availability. Mineral oils notably have the advantage of being good heat conductors and of being able to efficiently evacuate the heat produced by the current and through the windings and the magnetic circuit of a transformer, notably of a power transformer. The term “power transformer” refers to a transformer which has an apparent power strictly greater than 3 MVA (in three-phase supply). Transformers with a power of less than or equal to 3 MVA are distribution transformers.

However, the use of mineral oils poses environmental problems, in particular in the event of leaks, and safety problems in the event of a fire since they have a flash point and an ignition point which may prove to be too low according to the operating temperature of the transformer. In other words, mineral oils have good dielectric and thermal performance but their use demands that specific precautions be envisaged in terms of safety and of processing of the waste arising at the end of the service life of the oil and/or of the transformer.

In order to overcome these drawbacks, alternative fluids, notably based on silicone oils or synthetic and natural esters, such as plant oils and fatty acid esters, have been developed. Specifically, esters are biodegradable and silicone oils are inert. Furthermore, the alternative fluids generally have flashpoints and ignition points that are twice as high as mineral oil, which reduces any risks of ignition, or even of explosion, of the transformer.

To this end, WO 2016/167176 discloses a dielectric fluid comprising at least one fatty acid ester.

However, their use all too often remains limited on account of their high cost and of their poor dielectric and thermal performance. In particular, the alternative fluids have low capacity for evacuation of heat during heating of the transformer, which may in certain cases entail a change in the design of the fluid circulation channels inside the transformer, notably leading to their enlargement. Furthermore, their poor chemical stability and oxidation resistance generally necessitate the systematic presence of numerous additives.

In other words, these fluids prove to be more environmentally friendly than mineral oils, but have poorer thermal performance which tends to lead to an increase in the size of the transformers, and consequently of their cost.

Furthermore, the service life of transformers implemented using such fluids does not exceed that of transformers implemented with mineral oils.

Specifically, the fluids generally used as insulating materials in transformers, notably power transformers, gradually lose their dielectric properties with age, caused by the operating conditions, and above all by the temperature. In addition, the use of fluids with better heat exchange properties enables transformers to function at lower temperatures, which might increase their service life.

In this regard, other dielectric fluids were thus commercialized, for example complex hydrocarbon mixtures obtained by refining petroleum-based mineral oils.

Thus, U.S. Pat. No. 4,523,044 discloses dielectric fluids predominantly consisting of benzyltoluene oligomers and a small proportion of ditolylphenylmethane oligomers.

In addition, the replacement of transformers at the end of their service life with new transformers is a source of high expenditure. Manufacturers generally choose the “retro-filling” solution since it is economically advantageous, even though it might be a source of problems associated, for example, with changing of the old fluid which is not necessarily correctly performed. Furthermore, the design of the transformer is not always suited to the new fluid.

Moreover, cellulose-based insulation (known as paper insulation) has also been designed to provide an insulating material which has better dielectric and thermal performance.

Such insulation may be prepared using layers of papers and/or of polymer films, such as polypropylene films, which are superposed and dried, and then impregnated with dielectric fluids.

However, a paper-based insulating material has greater affinity for water. Thermal degradation of the paper produces water which preferentially remains in the paper, which usually leads to deterioration of the dielectric properties of the insulating material.

In other words, there is a real need to propose dielectric fluids that are capable of improving the service life of transformers without having an impact on their performance or their size, i.e. while at the same time maintaining an improvement in the reduction of their size.

Thus, one of the objects of the present invention is to develop dielectric fluids with increased thermal stability, improved thermal exchange properties, notably higher than those of mineral oils, and also optimized electrical performance so as to improve the service life of transformers.

In the light of the foregoing, one object of the invention is more particularly to propose dielectric fluids with suitable properties for improving the service life of transformers.

The Applicant has discovered that this need can be met by means of the use of a particular mixture as dielectric fluid. More particularly, the Applicant has discovered that this need can be met by means of the use of a particular mixture as dielectric fluid in a transformer.

Thus, according to a first aspect, a subject of the present invention is the use of a mixture, as dielectric fluid, comprising a composition A comprising dibenzyltoluene and benzyltoluene, for improving the service life of a transformer, preferably a power transformer.

In other words, the invention relates to the use of a mixture as described previously for increasing the service life of a transformer. In other words, the invention relates to the use of a dielectric fluid comprising a composition A as described previously for increasing the service life of a transformer.

The use of such a mixture allows an improvement in the thermal performance and the heat exchange properties, notably by means of better efficiency as regards the evacuation of heat during the heating of the transformer. Specifically, this evacuation of heat is rapid by means of the use of such a mixture, which also enables a reduction in the temperature of the transformer, notably at full load. In particular, the mixture enables the evacuation of more heat by free convection and by forced convection.

Another advantage of the use according to the present invention is that said mixture also enables the aging of the paper to be slowed down. Specifically, when the insulator is paper-based, the fluid advantageously solubilizes the water, notably more than mineral oils.

By means of such a mixture, a gain in power of the transformer may be obtained for the same load of materials. Thus, the size of the transformer can be reduced while maintaining the same power.

The use of such a mixture enables an improvement in the electrical performance, notably by means of improved permittivity and dielectric strength. For the purposes of the invention, the dielectric strength, expressed in V/m, is the minimum electric field which causes the breakdown of a material, as mentioned in “Techniques de 'Ingénieur [Engineering Techniques] d2470: Liquides isolants en électrotechnique, presentation générale [Insulating liquids in electrotechnology, general presentation]”, by Noslle Berger, May 2002.

The mixture thus has thermal and electrical advantages while at the same time meeting the requirements in terms of environmental protection and safety.

It is specified that the expression “from . . . to . . . ” used in the present description should be understood as including each of the limits mentioned.

Other advantages and features of the invention will emerge more clearly on examining the detailed description.

As has been mentioned above, composition A comprises dibenzyltoluene and benzyltoluene. In the present invention, the names “dibenzyltoluene” and “benzyltoluene” comprise the respective partially or totally hydrogenated homologs thereof.

Thus, in composition A, dibenzyltoluene and benzyltoluene may be totally or partly replaced, preferably partly replaced, with one or more of the partially and/or totally hydrogenated homologs thereof, preferably the partially hydrogenated homologs thereof.

Composition A may also optionally comprise water within the meaning of the present invention. The water is nevertheless present in trace amount when composition A comprises any, such as in a content of less than or equal to 100 ppm relative to the total content of composition A. The water that may be present is, however, preferably not added during the preparation of composition A, but may correspond to the residual water provided by the mixed ingredients.

The traces of water that may be present in composition A may also originate from other sources of water in trace amount which are present in the dielectric fluid during its use in a transformer. For example, and in a nonlimiting manner, the water may be derived from the degradation of the paper present in said transformer and become mixed with the dielectric fluid.

This composition A may be prepared from commercial compounds taken separately or else obtained according to a process of coupling of benzyl chloride with toluene in the presence of a Friedel-Crafts catalyst, followed by distillation.

Preferably, composition A is prepared according to a process as described in EP 0 435 737, which uses ferric chloride as catalyst. The reaction may be performed at a temperature of from 50° C. to 150° C. The reaction mixture obtained is generally treated in order to remove, firstly, the excess toluene by distillation and, secondly, the organochlorine products formed (for example by placing in contact, at high temperature and with stirring, with an alkoxide).

The partially and/or totally hydrogenated homologs mentioned above may be readily obtained by partial or total hydrogenation of the mixture present in composition A or by partial or total hydrogenation of each of the components of composition A, and then mixed. The hydrogenation reactions and the operating conditions are now well known to those skilled in the art, and these hydrogenation reactions are advantageously catalytic reactions performed under hydrogen pressure according to known and available procedures.

The benzyltoluene may be in the form of any isomer, notably chosen from ortho- (CAS 713-36-0), para- (CAS 620-83-7) and meta-benzyltoluene, and mixtures thereof (notably CAS 27776-01-8). Use may be made of any isomer of dibenzyltoluene and mixtures thereof (CAS 26898-17-9, CAS 53585-53-8).

According to a preferred embodiment, composition A comprises:
from 2% to 30% by weight of dibenzyltoluene, relative to the total weight of composition A; and
from 70% to 98% by weight of benzyltoluene, relative to the total weight of composition A.

Advantageously, composition A comprises from 10% to 30% by weight of dibenzyltoluene, preferably from 12% to 28% by weight and more preferentially from 22% to 25% by weight, relative to the total weight of composition A.

More advantageously, composition A comprises from 70% to 90% by weight of dibenzyltoluene, preferably from 72% to 88% by weight and more preferentially from 75% to 78% by weight, relative to the total weight of composition A.

Particularly preferably, composition A consists of 25% by weight of dibenzyltoluene and 75% by weight of benzyltoluene, relative to the total weight of composition A. An example of composition A is notably commercially available from the company Arkema under the trade name Jarytherm® BT06.

As indicated previously, the invention relates to the use of a dielectric fluid comprising a composition A as described previously for increasing the service life of a transformer. The dielectric fluid that may be used in the context of the present invention and comprising composition A may contain one or more other components, among which mention may be made of esters, oils, for example mineral oils, and also additives of any type that are well known to a person skilled in the art who is a specialist in transformers.

According to a preferred aspect of the present invention, the dielectric fluid that may be used in the context of the present invention comprises a composition A as defined previously and at least one ester, preferably at least one organic acid ester. Mixtures comprising a composition A as defined previously and at least one ester are novel and, in this respect, also form part of the present invention.

Said at least one organic acid ester which may be present in the dielectric fluid that may be used in the context of the present invention may be of any type that is well known to those skilled in the art and is preferably chosen from natural, artificial or synthetic fatty esters, and more preferably from monoesters, diesters, triesters or tetraesters obtained by reaction between at least one monocarboxylic or dicarboxylic fatty acid including from 5 to 30 carbon atoms with a linear or branched alcohol, diol, triol or tetrol.

According to a preferred embodiment of the present invention, said at least one ester is chosen from the group consisting of the esters of formulae (I) and (II) below:

R¹—C(O)O—R² (I)

R³—C(O)—O—CH₂—CH(OC(O)R⁴)—CH₂—O—C(O)—R⁵ (II),

in which:
R¹ denotes a saturated or unsaturated, linear or branched carbon-based chain comprising from 5 to 30 carbon atoms and preferably 5 to 20 carbon atoms;
R² denotes a saturated or unsaturated, linear or branched carbon-based chain comprising from 1 to 10 carbon atoms, for example methyl, ethyl, propyl, butyl, 2-ethylhexyl, 2-octyl or decyl,
R³, R⁴ and R⁵ denote, independently of each other, a saturated or unsaturated, linear or branched carbon-based chain comprising from 5 to 20 carbon atoms.

Preferably, R¹ comprises from 7 to 20 carbon atoms. Preferably, R² comprises from 1 to 5 carbon atoms. Preferably, R³, R⁴ and R⁵ denote an identical carbon-based chain.

According to a most particularly advantageous embodiment of the present invention, said at least one ester is chosen from the group consisting of plant esters, plant oils and mixtures thereof.

Among the plant esters, mention may be made in a nonlimiting manner, and for purely illustrative purposes, of methyl glutarate, ethyl glutarate, methyl oleate, butyl oleate, methyl succinate, 1-methylpropyl succinate, methyl esters of castor oil, and esters of animal fat, such as methyl esters of tallow.

Said esters may also be glycerides, for example those present in plant oils, such as olive oil, rapeseed oil, cocoa bean oil, peanut oil, mustard oil, castor oil, cottonseed oil, sunflower oil, corn oil, safflower oil, palm oil, coconut oil, sesame oil, rice oil, linseed oil, grapeseed oil and soybean oil.

Among the synthetic esters that may be used in the context of the present invention, nonlimiting examples that may be mentioned include the compounds of the brand name Midel® sold by the company M&I, to mention but a few thereof.

According to another most particularly preferred embodiment, the ester(s) which may be present in the dielectric fluid that may be used in the context of the present invention are those with a viscosity of less than or equal to 0.1 Pa·s at 20° C., more preferentially less than or equal to 0.06 Pa·s at 20° C., even more preferentially less than or equal to 0.04 Pa·s at 20° C. The viscosity is measured using an Ubbelohde glass capillary viscometer according to the standard ISO 3104.

An example of such an ester is commercially available from the company Arkema under the trade name Esterol® F.

Advantageously, the mixture comprises from 72% to 96% by weight of composition A, preferably from 72% to 85% by weight, relative to the total weight of the mixture. Advantageously, the weight content of ester ranges from 2% to 26% by weight, preferably from 10% to 20% by weight, relative to the total weight of the mixture.

According to a preferred embodiment, the dielectric fluid that may be used in the context of the present invention also comprises at least one additive chosen from the group consisting of antioxidants, passivating agents, flow point reducers, decomposition inhibitors and mixtures thereof. A dielectric fluid that is most particularly preferred comprises a decomposition inhibitor.

Among the antioxidants that may be advantageously used in the dielectric fluid, nonlimiting examples that may be mentioned include:
phenolic antioxidants, such as dibutylhydroxytoluene, butylhydroxyanisole, phenyl-α-naphthylamine or N,N-bis(2-naphthyl)-para-phenylenediamine;
antioxidants of amine type, for example of diamine type, such as tocopherol, d-tocopherol, DL-α-tocopherol, α-tocopheryl acetate, DL-α-tocopheryl acetate, tocopheryl acetate, α-tocopherol, ascorbic acid, ascorbic acid salts, ascorbic acid esters, alone or as a mixture of two or more thereof or with other components, for instance green tea extracts or coffee extracts.

An example of such an antioxidant is commercially available from the company Brenntag under the trade name Ionol.

The passivating agents that may be used as additives in the dielectric fluid that may be used in the context of the present invention are of any type known to those skilled in the art and are advantageously chosen from triazole derivatives, benzimidazoles, imidazoles, thiazole and benzothiazole. Nonlimiting examples that may be mentioned include dioctylaminomethyl-2,3-benzotriazole and 2-dodecyldithioimidazole.

Among the flow point reducers which may be present in the dielectric fluid that may be used in the context of the present invention, nonlimiting examples that may be mentioned include fatty acid esters of sucrose and acrylic polymers such as poly(alkyl methacrylate) or poly(alkyl acrylate).

The preferred acrylic polymers are those with a molecular weight of between 50 000 g mol⁻¹ and 500 000 g mol⁻¹. Examples of these acrylic polymers include polymers that may contain linear alkyl groups comprising from 1 to 20 carbon atoms.

Among these, and still as nonlimiting examples, mention may be made of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a flow point reducer is commercially available from the company Sanyo Chemical Industries under the trade name Aclube.

According to a most particularly preferred aspect, the dielectric fluid that may be used in the context of the present invention comprises at least one decomposition inhibitor as additive. The decomposition inhibitor may be of any type that is well known to those skilled in the art and may be chosen in particular from:
carbodiimide derivatives such as diphenylcarbodiimide, ditolylcarbodiimide, bis(isopropylphenyl)carbodiimide and bis(butylphenyl)carbodiimide;
phenyl glycidyl ethers or esters;
alkyl glycidyl ethers or esters;
3,4-epoxycyclohexylmethyl(3,4-epoxycyclohexane) carboxylate;
epoxidized derivatives such as vinylcyclohexene diepoxides, 3,4-epoxy-6-methylcyclohexylmethyl(3,4-epoxy-6-methylhexane) carboxylate, epoxy resins of phenol novolac type, bisphenol A diglycidyl ether epoxy, such as DGEBA or CEL 2021P, which are notably available from the company Whyte Chemical.

According to a particular embodiment of the invention, the mixture comprises a composition A and at least one decomposition inhibitor. Advantageously, the mixture comprises a composition A, at least one ester and at least one decomposition inhibitor.

The weight content of the additive(s) possibly present in the dielectric fluid that may be used in the context of the present invention may range from 0.0001% to 2% by weight, preferably from 0.001% to 1% by weight and more preferentially from 0.01% to 0.5% by weight, relative to the total weight of the mixture.

As indicated previously, another subject of the present invention is a mixture comprising:
a composition A, as defined previously;
at least one organic acid ester; and
optionally at least one additive.

According to a preferred embodiment, the mixture comprises:
a composition A, said composition A comprising:
from 2% to 30% by weight of dibenzyltoluene, advantageously from 10% to 30% by weight of dibenzyltoluene, preferably from 12% to 28% by weight and more preferentially from 22% to 25% by weight, relative to the total weight of composition A; and
from 70% to 98% by weight of benzyltoluene, advantageously from 70% to 90% by weight, preferably from 72% to 88% by weight, more preferentially from 75% to 78% by weight, relative to the total weight of composition A;
at least one organic acid ester preferably chosen from natural, artificial or synthetic fatty esters, and more preferably from monoesters, diesters, triesters or tetraesters obtained by reaction between at least one monocarboxylic or dicarboxylic fatty acid including from 5 to 30 carbon atoms with a linear or branched alcohol, diol, triol or tetrol; and
optionally at least one additive.

According to another preferred embodiment, the mixture described above comprises:
from 72% to 96% by weight of composition A, preferably from 72% to 85% by weight of composition A, relative to the total weight of the mixture;
from 2% to 26% by weight, preferably from 10% to 20% by weight, relative to the total weight of the mixture, of at least one organic acid ester; and
optionally at least one additive, the total content of additives (when present) ranging from 0.0001% to 2% by weight, preferably from 0.001% to 1% by weight, more preferentially from 0.01% to 0.5% by weight, relative to the total weight of the mixture.

According to yet another preferred embodiment, the mixture described above comprises:
from 72% to 96% by weight of composition A, preferably from 72% to 85% by weight, relative to the total weight of the mixture, said composition A comprising:
from 2% to 30% by weight of dibenzyltoluene, advantageously from 10% to 30% by weight of dibenzyltoluene, preferably from 12% to 28% by weight and more preferentially from 22% to 25% by weight, relative to the total weight of composition A; and
from 70% to 98% by weight of benzyltoluene, advantageously from 70% to 90% by weight, preferably from 72% to 88% by weight, more preferentially from 75% to 78% by weight, relative to the total weight of composition A;
from 2% to 26% by weight, preferably from 10% to 20% by weight, relative to the total weight of the mixture, of at least one organic acid ester preferably chosen from natural, artificial or synthetic fatty esters, and more preferably from monoesters, diesters, triesters or tetraesters, obtained by reaction between at least one monocarboxylic or dicarboxylic fatty acid including from 5 to 30 carbon atoms with a linear or branched alcohol, diol, triol or tetrol; and
optionally at least one additive chosen from the group consisting of antioxidants, passivating agents, flow point reducers, decomposition inhibitors and mixtures thereof, the total content of additives (when present) ranging from 0.0001% to 2% by weight, preferably from 0.001% to 1% by weight, more preferentially from 0.01% to 0.5% by weight, relative to the total weight of the mixture.

According to yet another preferred embodiment, the mixture according to the invention comprises at least one ester chosen from the group consisting of the esters of formulae (I) and (II) described above.

As indicated previously, the mixture as described previously, which may be used as dielectric fluid, enables an improvement in the service life of a transformer.

Preferably, the mixture according to the invention is used for improving the service life of distribution, power or measurement transformers, or high-voltage transformers, preferably distribution and power transformers. More preferentially, the mixture according to the invention is used for improving the service life of power transformers.

According to yet another aspect, the present invention relates to a transformer, preferably a power transformer, comprising a composition A as defined previously, preferably comprising a mixture as defined previously.

The present invention will be better understood with the aid of the following examples, which are given purely by way of illustration and without any intention to limit the scope of the invention.

### EXAMPLES

### 1. Preparation of Dielectric Fluids

A comparative dielectric fluid (B) and two dielectric fluids that may be used in the context of the invention (C and D) are prepared according to the compositions as indicated in Table 1 below:

TABLE 1

| Fluid | B (comp.) | C (inv.) | D (inv.) |
|---|---|---|---|
| Mineral oil¹ (weight %) | 100 | | — |
| Composition A² (weight %) | — | qs 100 | qs 100 |
| CEL2021P³ (weight %) | — | 0.2 | 0.2 |
| Esterol ® F (weight %) | — | — | 14.9 |

¹Nytro Libra mineral oil (non-inhibited mineral oil sold by Nynas)
²Composition A: Jarytherm ® BT06, sold by the company Arkema, and consisting of 25% by weight of dibenzyltoluene, relative to the total weight of composition A, and 75% by weight of benzyltoluene, relative to the total weight of composition A
³Decomposition inhibitor, available from the company Whyte Chemical

### 2. Evaluation and Results

a. Study of the Aging of Paper

The water content of fluids B and C was measured before impregnation of paper in each of these fluids. It is, respectively, 20.8 ppm for fluid B and 81.4 ppm for fluid C. Paper was then impregnated with fluid B and fluid C. The aging of the paper in each of these fluids was studied at various temperatures and times.

Thus, fluids B and C are tested at 70° C., 100° C. and 130° C. for times of 250 hours and 500 hours, respectively. The water content was measured at room temperature. The degree of polymerization was measured for the experiments conducted at 100° C. and 130° C. The results are collated in Table 2 below.

TABLE 2

| | | | Water content | |
|---|---|---|---|---|
| | Temperature | Time | of the fluids | Degree of |
| Fluid | (° C.) | (h) | (ppm) | polymerization |
| B (comp.) | 70 | 250 | 3.0 | — |
| C (inv.) | 70 | 250 | 38.8 | — |
| B (comp.) | 70 | 500 | 3.8 | — |
| C (inv.) | 70 | 500 | 22.1 | — |
| B (comp.) | 100 | 250 | 0.1 | 640 |
| C (inv.) | 100 | 250 | 22.0 | 920 |
| B (comp.) | 100 | 500 | 0.5 | 490 |
| C (inv.) | 100 | 500 | 21.2 | 1000 |
| B (comp.) | 130 | 250 | 0 | 350 |
| C (inv.) | 130 | 250 | 14.4 | 780 |
| B (comp.) | 130 | 500 | 0.5 | 410 |
| C (inv.) | 130 | 500 | 18.4 | 790 |

Before impregnation of the paper, the water content in the fluids is high. The water, being more soluble in the paper, migrates into the paper in the course of the impregnation at room temperature.

In comparison with fluid B (comparative), the water content in fluid C (according to the invention) is always higher, irrespective of the temperature and time of the tests. This indicates that the water migrates faster into fluid C, which keeps the paper drier than fluid B, by means of the greater solubility of water in fluid C, at a given temperature, relative to fluid B.

Comparison of the degrees of polymerization clearly shows that the degradation of the paper is approximately twice as pronounced with fluid B, irrespective of the duration of the aging relative to fluid C.

b. Evaluation of the Thermal Performance

The thermal performance of fluids B, C and D is evaluated. In a 400 KV transformer with an oil capacity of 400 L and functioning in free convection, the temperature difference of the fluid between the inlet (or outlet) of the transformer and the outlet of the condenser was measured. The results are indicated in Table 3 below:

TABLE 3

| Fluid | B (comp.) | C (inv.) | D (inv.) |
|---|---|---|---|
| Transformer outlet temperature (° C.) | 90 | 84 | 87 |
| Condenser outlet temperature (° C.) | 40 | 30 | 35 |
| Δ Temperature (° C.) | 50 | 54 | 52 |

Table 3 clearly shows a greater temperature difference between the outlet of the transformer and the outlet of the condenser when fluids C and D are used relative to fluid B.

Thus, better heat evacuation may be observed when the dielectric fluids C and D are used. The use of the dielectric fluids C or D thus enables more efficient heat exchange.

More efficient heat exchange contributes toward slowing down the aging of the paper in which the dielectric fluids are impregnated, and consequently toward improving the service life of a transformer.

1. A method of using a mixture as a dielectric fluid, the mixture comprising a composition A comprising dibenzyltoluene and benzyltoluene, for improving the service life of a transformer.

2. The method as claimed in claim 1, wherein the composition A comprises:
from 2% to 30% by weight of dibenzyltoluene, relative to the total weight of composition A; and
from 70% to 98% by weight of benzyltoluene, relative to the total weight of composition A.

3. The method as claimed in claim 1, wherein the composition A comprises from 10% to 30% by weight of dibenzyltoluene, relative to the total weight of composition A.

4. The method as claimed in claim 1, wherein the composition A comprises from 70% to 90% by weight of benzyltoluene, relative to the total weight of composition A.

5. The method as claimed in claim 1, wherein the mixture also comprises at least one ester.

6. The method as claimed in claim 5, wherein the ester is chosen from the group consisting of the esters of formulae (I) and (II) below:
R¹—C(O)O—R² (I)
R³—C(O)—O—CH₂—CH(OC(O)R⁴)—CH₂—O—C(O)—R⁵ (II),
in which:
R¹ denotes a saturated or unsaturated, linear or branched carbon-based chain comprising from 5 to 30 carbon atoms;
R² denotes a saturated or unsaturated, linear or branched carbon-based chain comprising from 1 to 10 carbon atoms,
R³, R⁴ and R⁵ denote, independently of each other, a saturated or unsaturated, linear or branched carbon-based chain comprising from 5 to 20 carbon atoms.

7. The method as claimed in claim 5, wherein the mixture comprises from 72% to 96% by weight of composition A, relative to the total weight of the mixture.

8. The method as claimed in claim 5, wherein the weight content of ester ranges from 2% to 26% by weight, relative to the total weight of the mixture.

9. The method as claimed in claim 5, wherein the mixture comprises at least one additive chosen from the group consisting of an antioxidant, a passivating agent, a flow point reducer, a decomposition inhibitor and mixtures thereof.

10. The method as claimed in claim 9, wherein the weight content of the additive ranges from 0.0001% to 2% by weight, relative to the total weight of the mixture.

11. A mixture comprising:
the composition A as defined in claim 1;
at least one organic acid ester; and
optionally at least one additive.

12. The mixture as claimed in claim 11, comprising:
a composition A as defined, said composition A comprising:
from 2% to 30% by weight of dibenzyltoluene, relative to the total weight of composition A; and
from 70% to 98% by weight of benzyltoluene, relative to the total weight of composition A;
at least one organic acid ester preferably chosen from natural, artificial or synthetic fatty esters obtained by reaction between at least one monocarboxylic or dicarboxylic fatty acid including from 5 to 30 carbon atoms with a linear or branched alcohol, diol, triol or tetrol; and
optionally at least one additive.

13. The mixture as claimed in claim 11, comprising:
from 72% to 96% by weight of composition A as defined, relative to the total weight of the mixture;
from 2% to 26% by weight, relative to the total weight of the mixture, of at least one organic acid ester; and
optionally at least one additive, the total content of additives (when present) ranging from 0.0001% to 2% by weight, relative to the total weight of the mixture.

14. The mixture as claimed in at claim 11, comprising:
from 72% to 96% by weight of composition A as defined, relative to the total weight of the mixture, said composition A comprising:
from 2% to 30% by weight of dibenzyltoluene, relative to the total weight of composition A; and
from 70% to 98% by weight of benzyltoluene, relative to the total weight of composition A;
from 2% to 26% by weight, relative to the total weight of the mixture, of at least one organic acid ester obtained by reaction between at least one monocarboxylic or dicarboxylic fatty acid including from 5 to 30 carbon atoms with a linear or branched alcohol, diol, triol or tetrol; and
optionally at least one additive chosen from the group consisting of antioxidants, passivating agents, flow point reducers, decomposition inhibitors and mixtures thereof, the total content of additives (when present) ranging from 0.0001% to 2% by weight, relative to the total weight of the mixture.

15. A transformer comprising a composition A as defined in claim 1.
